(19) United States
(12) Patent Application Publication
(10) Pub. No.: US 2008/0121852 A1
(43) Pub. Date: May 29, 2008

(54) Double Drive for Adjusting Parts of a Piece of Furniture

(75) Inventor: Dietmar Koch, Lontzen (BE)

Correspondence Address: GROSSMAN, TUCKER, PERREAULT & PFLEGER, PLLC, 55 SOUTH COMMERICAL STREET, MANCHESTER, NH, 03101, US

(73) Assignee: OKIN GESELLSCHAFT FUR ANTRIEBSTECHNIK MBH, Gummersbach (DE)

(21) Appl. No.: 11/569,298

(22) PCT Filed: May 13, 2005
(86) PCT No.: PCT/DE05/00901

§ 371 Date: Dec. 12, 2007

(30) Foreign Application Priority Data
May 17, 2004 (DE) 10 2004 024 369.7
May 17, 2004 (DE) 20 2004 020 384.7

(51) Int. Cl. B66F 3/25

(52) U.S. Cl. 254/100

(57) ABSTRACT

The invention relates to a double drive, for adjusting parts of a piece of furniture, in particular, parts of a slatted bed base. Said double drive consists of two linear drives (2, 3) which each comprise an electric motor with a transmission (5), a shaft (6), coupled thereto, a nut (7), guided by said shaft and a contact surface (8), arranged on the nut (7) or on a sliding part, linked thereto, whereby a control lever (9), cooperating with the part of the piece of furniture to be adjusted, abuts against said surface. The electric motors and transmissions (5) are arranged between the contact surfaces (8) and the normal to the contact surfaces (8) extends from the electric motors and transmissions (5). In order to provide a double drive which is as compact as possible, the contact surfaces (8) are arranged along the shafts (6) laterally and on the longitudinal extension of the shafts (6) in each position of the nuts (7), both linear drives (2, 3) are housed in a common housing (1) and the transmissions (5), the shafts (6) and the nuts (7) or sliding parts, guided by said shafts, are mounted in retaining devices which are integrally moulded on said housing (1).

The invention relates to a double drive for adjusting parts of a piece of furniture, particularly parts of a slatted bed base, having two linear drives, each of which comprises an electric motor with a transmission unit, a spindle coupled thereto, a nut guided by said spindle, and a contact surface, arranged on the nut or on a sliding part connected thereto, against which a control lever cooperating with the part of the piece of furniture to be adjusted abuts, where the electric motors and the transmission units are located in the area between the contact surfaces, and the normals to the surface of the contact surfaces point away from the electric motors and the transmission units.

A double drive of this kind is known from DE 38 42 078 A1, for example. It is a drive for slatted bed bases, where pivoting parts of a slatted bed base, such as the head end, middle section or foot end, are raised or lowered via the two linear drives. The contact surfaces cooperating with the control levers are provided on sliding parts, which are connected to the nuts and extend beyond the ends of the spindles pointing away from each other. The control levers lying loosely against the contact surfaces in front of the spindles are connected in non-rotating fashion to shafts mounted in the piece of furniture, e.g. in the longitudinal members of a slatted bed base, where the movable parts, e.g. the head end, middle section or foot end, can be adjusted via brackets linked to said shafts.

Since the normals to the surface of the contact surfaces point away from the electric motors and the transmission units, which are located in the area between the contact surfaces, pressure is exerted on the contact surfaces in the direction of the electric motors and the transmission units during adjustment, particularly when driving the nuts or sliding parts in the direction of the normals to the surface of the contact surfaces. If the electric motors and transmission units are located opposite each other, the pressure forces pointing towards each other are particularly advantageously absorbed by them and by the housing in which the two linear drives are mounted.

Since, in the known double drive, the contact surfaces for the control levers extend beyond the ends of the spindles pointing away from each other, and are thus located in front of the ends of the spindles, the distance between the two contact surfaces is at least twice the length of the two spindles. The double drive thus displays a longitudinal extension that is limited by the length of the spindles and cannot be reduced.

In many cases, however, it is desirable to design the double drive with a more compact longitudinal extension.

In a double drive known from DE 88 00 360 U1, the linear drives are not arranged in a common plane, but located laterally next to each other. A force transmitted via the linear drives to the control levers of the shafts generates a reaction force acting on the spindles and the transmission units, which acts on the shafts in planes that are laterally offset relative to each other. Owing to this, a resultant torque acting on the double drive is generated.

In another double drive, known from DE 197 18 255 C1, the two linear drives lie next to each other in the plane perpendicular to the shafts. A resultant torque in the plane of the two shafts is avoided by the fact that the linear drives are not offset relative to each other in the longitudinal direction of the shafts. However, a resultant torque is generated about an axis running parallel to the shafts, which can negatively impact the stability of the double drive. Moreover, the absorption of the pressure forces by the housing can be regarded as disadvantageous in the case of linear drives offset relative to each other.

Consequently, the object of the present invention is, while avoiding the aforementioned disadvantages, to provide a double drive that is particularly compact and absorbs the pressure forces occurring as reaction forces in particularly favorable fashion.

According to the invention, the object is solved in that, on a double drive of the kind mentioned in the opening paragraph, the contact surfaces for the control levers are located laterally and in the area of the longitudinal extension of the spindles in any position of the nuts along the spindles, the two linear drives are mounted in a common housing, and the transmission units, the spindles, and the nuts or sliding parts guided by them, are mounted in the housing by holding devices integrally fashioned on the housing in one piece.

Owing to the design according to the invention, the distance between the contact surfaces is no longer dependent on the distance between the spindle ends pointing away from each other, and is greatly reduced. As a result, the double drive can be designed with a considerably more compact longitudinal extension. In this compact design, the two linear drives can be arranged opposite to each other in such a way that the spindle axes lie in one plane. This arrangement permits optimum absorption of the pressure forces acting on the nuts, spindles and transmission units as reaction forces of the control levers.

As a result of the feature according to the invention, whereby the transmission units, the spindles, and the nuts or sliding parts guided by them, are mounted in a common housing by holding devices integrally fashioned on the housing in one piece, the pressure forces occurring as reaction forces are optimally absorbed by the housing, without separate holding devices being necessary for this purpose.

In the case of a milled housing, which can advantageously consist of two shells, the holding devices are milled out on the inside of the shells. The transmission components, spindles and nuts, with sliding parts located thereon where appropriate, can easily be inserted into one housing shell and then mounted in the holding devices by fastening the two shells together. To save weight, the holding devices can consist of web-like parts that close around the transmission components, the spindle bearing and the nuts, or the sliding parts connected to the nuts, at the envisaged points.

The contact surfaces can in each case display a surface area located on one side and in the area of the longitudinal extension of the associated spindle, against which the control lever can be positioned loosely, i.e. without a connection to the contact surface.

Preferably, each contact surface displays two surfaces areas, located on both sides and in the area of the longitudinal extension of the associated spindle, against each of which one limb of a two-limb control lever can be positioned loosely. In this context, the forces are distributed symmetrically in reference to the spindle axis and the nut.

The two surface areas are preferably arranged in alignment with each other on the two sides of the associated spindle, such that the two limbs of the control lever can be designed symmetrically in relation to each other.

The limbs of the control levers are preferably of angled design, with one arm part linked to the associated shaft and one arm part arranged at an angle thereto and extending towards the respective contact surface. Since the angle between the arm part extending towards the respective contact surface and the spindle axis changes when the control lever pivots, it may be expedient, depending on the arrangement and angular position of the arm parts, to design the contact surface at an angle relative to the spindle axis, so that, as far as possible, the forces act in the longitudinal direction of the arm part pointing towards the contact surface.

To exploit the greatest possible lever length of the control levers with a compact height of the double drive, the longitudinal axes of the spindles can be arranged to be inclined towards each other, away from the control levers.

In a preferred embodiment of the invention, the ends of the two spindles are mounted in rotational bearings, particularly ball bearings.

In a special embodiment of the double drive, the transmission unit of each linear drive displays a worm gear unit, with a worm driven by the electric motor, and a worm wheel engaging the worm, where the worm wheel is located in non-rotating fashion on one end of the spindle or an extension of the spindle.

The double drive according to the invention expediently displays a housing, in which both linear drives are mounted and extend towards ends of the housing pointing away from each other. Particularly if the double drive is used for adjusting parts of furniture used for sitting or lying, the sides of the end areas of the housing pointing towards the adjustable parts are provided with recesses, into which the shafts can be inserted that are connected to the adjustable parts via brackets. The side of the recesses pointing towards the adjustable parts can be closed by slide-like covers, such that the double drive can be suspended by the two shafts.

The double drive according to the invention expediently displays a control unit for the linear drives, which is located between the ends of the spindles pointing away from each other in order to obtain a compact design of the double drive.

The control unit is expediently located in the common housing, and fixed in place therein by the holding devices.

A preferred practical example of the invention is explained in more detail below on the basis of the drawing. The drawing shows the following:

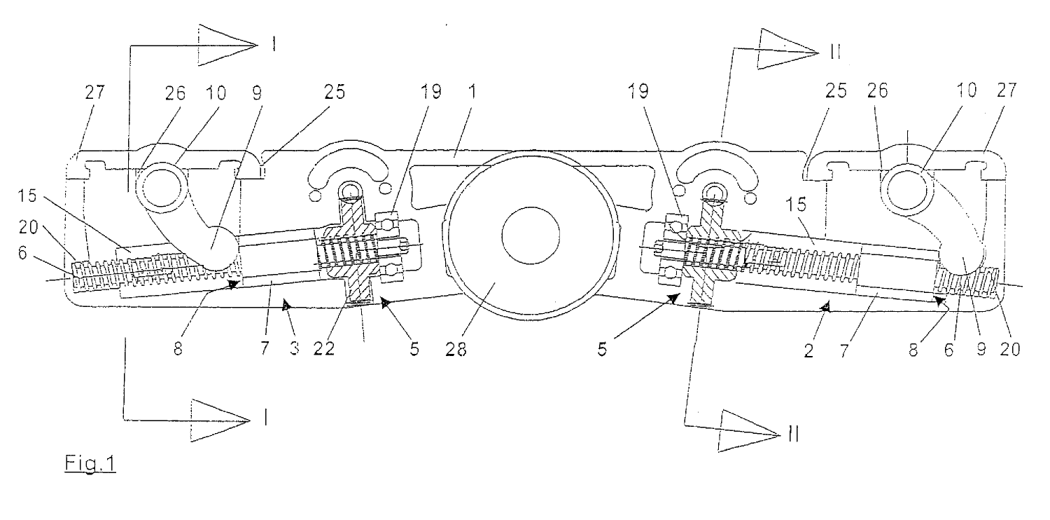

FIG. 1 A side view of the double drive, with laterally opened housing,

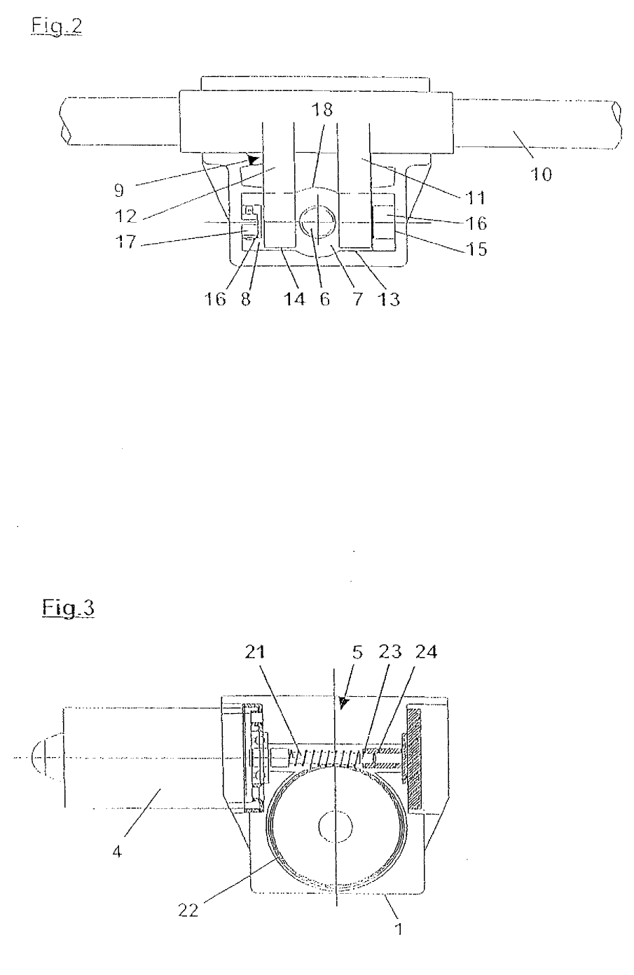

FIG. 2 A cross-sectional view of the double drive along line II-II in FIG. 1, and

FIG. 3 A cross-sectional view of the double drive along line III-III in FIG. 1.

As can particularly be seen from FIG. 1 of the drawing, the double drive essentially consists of a housing 1, in which two linear drives 2 and 3 are located.

The two linear drives 2 and 3 each display an electric motor 4 (cf. FIG. 3) with a transmission unit 5, a spindle 6 coupled thereto, a nut 7 guided by said spindle 6, and a contact surface 9, located on nut 7, against which a control lever 9, cooperating with the part of the piece of furniture to be adjusted, abuts. Electric motors 4 and transmission units 5 are located in the area between contact surfaces 8. The normals to the surface of contact surfaces 8 point away from electric motors 4 and transmission units 5, such that the reaction forces acting against control levers 9 when nuts 7 are moved are directed towards transmission units 5 as pressure forces. The reaction forces can thus advantageously be absorbed by the spindle bearing in the middle area of the housing and by the housing structure.

Transmission units 5, spindles 6, and nuts 7 guided by them, are mounted in holding devices that are integrally fashioned on housing 1 in one piece. The holding devices for transmission units 5 are designed in the form of closed transmission compartments that are integral elements of housing 1. Housing 1 is made up of two shells, one of which is shown in FIG. 1. The transmission compartment is closed by joining the two shells. In addition, the holding devices for the bearings of spindles 6, and for nuts 7 guided by spindles 6, are formed by webs that positively fix the bearings and nuts 7 in place when housing 1 is closed.

As can be seen in FIG. 1, nut 7 of linear drive 3 on the left is in its maximally retracted position relative to transmission unit 5, while nut 7 of linear drive 2 on the right is in its maximally extended position. The pivoting position of control levers 9 is thus likewise shown in the two extreme positions, such that the furniture part that can be pivoted via shaft 10 and a bracket linked to it (not shown in the drawing) is lowered in the position of control lever 9 shown on the left, and the furniture part that can be pivoted via shaft 10 and the bracket linked to it (not shown in the drawing) is swung out in the position shown on the right.

Contact surfaces 8 are located laterally and in the area of the longitudinal extension of spindles 6 in every position of nuts 7 along spindles 6. As a result of this arrangement, the distance between the two contact surfaces 8 can be kept as small as possible, such that the longitudinal extension of the double drive can be designed in compact form and housing 1 does not extend substantially beyond the ends of spindles 6 pointing away from each other.

As can particularly be seen from FIG. 2, control levers 9 are each of two-limb design, where each limb 11 and 12 rests against an associated surface area 13 or 14 of the associated contact surface 8. The two surface areas 13 and 14 are located on opposite sides of the spindle 6 in question, such that the pressure forces act symmetrically on nut 7 on both sides of spindle 6.

As can further be seen from FIGS. 1 and 2, nuts 7 have an essentially cuboid contour and are mounted in guide channels 15, which have a corresponding, rectangular cross-section and permit movement along spindles 6, but not rotation. To the side of surface areas 13 and 14, the outer sides of nuts 7 display recesses 16, which can be engaged by limit switches 17 provided at the ends of the travel path in guide channels 15. Limit switches 17 are preferably designed as microswitches. For reinforcement in the middle area around spindles 6, nuts 7 display semi-cylindrical bulges 18, which are guided in corresponding semi-cylindrical indentations in guide channels 15.

The longitudinal axes of spindles 6 are inclined away from shafts 10 in housing 1 in order to exploit the greatest possible lever length of control levers 9 and preserve the most compact possible height of housing 1, this essentially being defined by the vertical extension of transmission unit 5 and electric motor 4.

As shown in FIG. 1, the ends of spindles 6 adjacent to transmission units 5 are mounted in rotating fashion in ball bearings 19. The other ends of spindles 6 are mounted in rotational bearings 20, which can likewise be ball bearings. As can be seen from FIGS. 1 and 3, transmission units 5 are designed as worm gear units, with a worm 21 driven by electric motor 4, and a worm wheel 22 engaging worm 21, where worm wheel 22 is located in non-rotating fashion on the corresponding end of spindle 6. An extension 23 on the free end of worm 21 is mounted in a bearing bush 24 on the side opposite electric motor 4.

Housing 1 is made of plastic and designed in the form of two shells. The parting line of the two shells extends perpendicularly to shafts 10. The two shells are produced by milling and contain holding devices, integrally fashioned on their insides in one piece, for mounting transmission units 5, bearings 19 and 20 for spindles 6, and nuts 7 in guide channels 15 described above.

To accommodate shafts 10, the upper side of housing 1 displays recesses 25 in the area of its two ends. In the area of shafts 10, recesses 25 display essentially semi-circular openings 26, into which shafts 10 can be inserted, or by means of which housing 1 can be slid onto shafts 10 from below. Covers 27 are provided for fastening housing 1 to shafts 10, and can be slid laterally over recesses 25 in form-fitting fashion.

As can furthermore be seen from FIG. 1, the middle of housing 1 displays a cylindrical area 28 for accommodating a toroidal-core transformer belonging to the control unit. The mount for the toroidal-core transformer (not shown in the drawing) is likewise integrated in the housing in one piece. Instead of a toroidal-core transformer, it is obviously possible to use another suitable transformer, which is mounted in housing 1, in a correspondingly shaped area where appropriate.

As can be seen from FIG. 3, electric motor 4 is located in a housing that is fastened laterally to housing 1 for the double drive. As a result, electric motor 4 can easily be replaced, including worm 21 located on its drive shaft. On the other hand, the housing for electric motor 4 can also be integrally fashioned on housing 1 of the double drive in one piece.

### LIST OF REFERENCE NUMBERS

1 Housing
2 Linear drive
3 Linear drive
4 Electric motor
5 Transmission unit
6 Spindle
7 Nut
8 Contact surface
9 Control lever
10 Shaft
11 Limb
12 Limb
13 Surface area
14 Surface area
15 Guide channel
16 Recess
17 Limit switch
18 Bulge
19 Ball bearing
20 Rotational bearing
21 Worm
22 Worm wheel
23 Extension
24 Bearing bush
25 Recess
26 Opening
27 Cover
28 Cylindrical area

1. Double drive for adjusting parts of a piece of furniture, particularly parts of a slatted bed base, having two linear drives (2, 3), each of which comprises an electric motor (4) with a transmission unit (5), a spindle (6) coupled thereto, a nut (7) guided by said spindle (6), and a contact surface (8), arranged on the nut (7) or on a sliding part connected thereto, against which a control lever (9) cooperating with the part of the piece of furniture to be adjusted abuts, where the electric motors (4) and the transmission units (5) are located in the area between the contact surfaces (8), and the normals to the surface of the contact surfaces (8) point away from the electric motors (4) and the transmission units (5), and where the two linear drives are mounted in a common housing (1), and the transmission units (5), the spindles (6), and the nuts (7) guided by them, or the sliding parts connected to the nuts, are mounted by holding devices integrally fashioned on the housing (1) in one piece, characterized in that the contact surfaces (8) are located laterally and in the area of the longitudinal extension of the spindles (6) in any position of the nuts (7) along the spindles (6), and in that a control unit for the linear drives (2, 3) is located in the housing (1) between the ends of the spindles (6) pointing away from each other, and fixed in place thereon by holding devices.

2. Double drive according to claim 1, characterized in that the housing consists of two milled shells, where the holding devices are milled out on the inside of the shells.

3. Double drive according to claim 1, characterized in that the contact surfaces display two surface areas, located on both sides and in the area of the longitudinal extension of the spindles, against each of which one limb of a two-limb control lever can be positioned.

4. Double drive according to claim 4, characterized in that the two surface areas are arranged in alignment with each other in one plane.

5. Double drive according to claim 1, characterized in that the contact surfaces are arranged at an angle to the longitudinal axes of the associated spindles.

6. Double drive according to claim 1, characterized in that the longitudinal axes of the spindles (6) are inclined towards each other.

7. Double drive according to claim 1, characterized in that the ends of the two spindles are mounted in rotational bearings, particularly ball bearings.

8. Double drive according to claim 1, characterized in that the transmission unit of each linear drive displays a worm gear unit, with a worm driven by the electric motor, and a worm wheel engaging the worm, where the worm wheel is located in non-rotating fashion on one end of the spindle or an extension of the spindle.

9-12. (canceled)

13. Double drive according to claim 1, characterized in that the holding devices for the control device are integrated in the housing in one piece.
